(19) United States
(12) Patent Application Publication
(10) Pub. No.: US 2024/0002250 A1
(43) Pub. Date: Jan. 4, 2024

(54) TANTALUM OXIDE PARTICLE AND METHOD FOR PRODUCING TANTALUM OXIDE PARTICLE

(71) Applicant: DIC Corporation, Tokyo (JP)

(72) Inventors: Shaowei YANG, Qingdao (CN); Jianjun YUAN, Chiba (JP); Masafumi UOTA, Chiba (JP); Mutsuko TANGE, Chiba (JP); Cheng LIU, Qingdao (CN); Meng LI, Qingdao (CN); Wei ZHAO, Qingdao (CN); Jian GUO, Qingdao (CN)

(21) Appl. No.: 18/253,669

(22) PCT Filed: Dec. 7, 2020
(86) PCT No.: PCT/CN2020/134307

§ 371 Date: May 19, 2023

(51) Int. Cl. C01G 39/00; C01G 35/00

(52) U.S. Cl. CPC C01G 39/00; C01G 35/00; C01P 2002/60; C01P 2002/72; C01P 2004/03; C01P 2002/85; C01P 2006/12; C01P 2004/30

(57) ABSTRACT

It relates to tantalum oxide particles containing molybdenum. The tantalum oxide particles preferably have a polyhedral shape, and the crystallite size of the tantalum oxide particles at 2θ=22.8° is preferably 160 nm or more. It also relates to a method for producing the tantalum oxide particles, the method including firing a tantalum compound in the presence of a molybdenum compound.

### TECHNICAL FIELD

The present invention relates to tantalum oxide particles and a method for producing tantalum oxide particles.

### BACKGROUND ART

Tantalum oxide has excellent dielectric characteristics, a high refractive index (2.16) within the visible light region, etc. and shows very high stability to high temperature, chemicals, and the like, and thus is widely used as an electronic ceramic material such as a capacitor, a dielectric material, a piezoelectric material, or the like, an optical material, a catalyst material, an electronics material, etc.

For example, PTL 1 discloses that an aqueous alcohol solution is added to an alcohol solution of tantalum alkoxide, thereby producing tantalum pentoxide fine particles of 1.0 to 1.5 μm by hydrolysis of tantalum alkoxide (claims, examples, etc.).

PTL 2 discloses that tantalum pentoxide is dissolved in alcohol, the solvent is directly evaporated or the solvent is evaporated after heating reflux, and then the residue is heated at 600° C. to 800° C., thereby producing tantalum pentoxide fine particles having an average dispersed particle diameter of 80 nm (claim 1, Example 7, etc.).

PTL 3 discloses that a solution containing a tantalum raw material and a surfactant is mixed with a mixed solvent of water and alcohol, the tantalum raw material is reacted in the mixed solvent to form tantalum oxide/surfactant composite fine particles containing the surfactant introduced into tantalum oxide, the tantalum oxide/surfactant composite fine particles are hydrothermally treated to form porous precursor fine particles, and the surfactant is removed from the porous precursor fine particles, thereby producing tantalum oxide meso-porous fine particles as amorphous particles.

### CITATION LIST

### Patent Literature

### [PTL 1]

Japanese Unexamined Patent Application Publication No. 62-91422

### [PTL 2]

Japanese Unexamined Patent Application Publication No. 2004-311315

### [PTL 3]

Japanese Unexamined Patent Application Publication No. 2011-136897

### SUMMARY OF INVENTION

### Technical Problem

However, any one of usual methods for producing tantalum oxide fine particles has difficulty in synthesizing tantalum oxide particles whose shapes can be stably controlled.

Accordingly, it is an object of the present invention to provide tantalum oxide particles whose shapes can be stably controlled, and to provide a production method therefor.

### Solution to Problem

The present invention includes the following aspects.
[1] Tantalum oxide particles containing molybdenum.
[2] The tantalum oxide particles described above in [1], wherein the tantalum oxide particles contain polyhedral-shaped particles.
[3] The tantalum oxide particles described above in [1] or [2], wherein the MoO₃ content (M₁) relative to 100% by mass of the tantalum oxide particles, determined by XRF analysis of the tantalum oxide particles, is 0.1% to 10.0% by mass.
[4] The tantalum oxide particles described above in any one of [1] to [3], wherein the Ta₂O₅ content (T₁) relative to 100% by mass of the tantalum oxide particles, determined by XRF analysis of the tantalum oxide particles, is 85.0% to 99.9% by mass.
[5] The tantalum oxide particles described above in any one of [1] to [4], wherein the crystallite size of the tantalum oxide particles at 2θ=22.8° is 160 nm or more.
[6] The tantalum oxide particles described above in any one of [1] to [5], wherein the crystallite size of the tantalum oxide particles at 2θ=36.6° is 100 nm or more.
[7] The tantalum oxide particles described above in any one of [1] to [6], wherein the Ta₂O₅ content (T₂) relative to 100% by mass of the surface layers of the tantalum oxide particles, determined by XPS surface analysis of the tantalum oxide particles, is 70.0% to 99.5% by mass, and the MoO₃ content (M₂) relative to 100% by mass of the surface layers of the tantalum oxide particles, determined by XPS surface analysis of the tantalum oxide particles, is 0.5% to 30.0% by mass.
[8] The tantalum oxide particles described above in any one of [1] to [7], wherein the molybdenum is selectively rich in the surface layers of the tantalum oxide particles.
[9] The tantalum oxide particles described above in any one of [1] to [8], wherein the specific surface area determined by a BET method is 10 m²/g or less.
[10] A method for producing tantalum oxide particles, including firing a tantalum compound in the presence of a molybdenum compound.
[11] The method for producing tantalum oxide particles described above in [10], wherein the molybdenum compound is molybdenum oxide.
[12] The method for producing tantalum oxide particles described above in or [11], wherein the maximum firing temperature of firing the tantalum compound is 800° C. to 1600° C.
[13] The method for producing tantalum oxide particles described above in any one of to [12], wherein the molar ratio of molybdenum atom in the molybdenum compound to tantalum atom in the tantalum compound is Mo/Ta=0.2 or more.

### Advantageous Effects of Invention

The present invention can provide tantalum oxide particles whose shapes can be stably controlled, and provide a production method therefor.

### BRIEF DESCRIPTION OF DRAWINGS

FIG. 1 is an SEM photograph of tantalum oxide particles of Example 1.

FIG. 2 is an SEM photograph of tantalum oxide particles of Example 2.

FIG. 3 is an SEM photograph of tantalum oxide particles of Example 3.

FIG. 4 is an SEM photograph of tantalum oxide particles of Comparative Example 1.

FIG. 5 is an SEM photograph of tantalum oxide particles of Comparative Example 2.

FIG. 6 is a graph showing X-ray diffraction (XRD) patterns of tantalum oxide particles of examples and comparative examples.

### DESCRIPTION OF EMBODIMENTS

### [Tantalum Oxide Particles]

Tantalum oxide particles according to an embodiment of the present invention are tantalum oxide particles containing molybdenum.

The tantalum oxide particles according to the embodiment of the present invention contain molybdenum and, in a production method described later, the particle shape can be stably controlled to a polyhedral shape by controlling the mixing amount and presence state of molybdenum, and thus the physical properties and performance of the tantalum oxide particles, for example, optical characteristics such as hue, transparency, and the like, can be arbitrarily adjusted according to applications of use.

In the present specification, the expression “the particle shape of the tantalum oxide particles is controlled” represents that the particle shape of the produced tantalum oxide particles is not shapeless. In the present specification, the expression “the tantalum oxide particles with controlled shape” represents the tantalum oxide particles with well-defined shape.

Tantalum oxide particles according to an embodiment, which are produced by a production method according to an embodiment of the present invention, have a characteristic euhedral shape such as a cubic shape, a prismatic shape, or another polyhedral shape as shown in examples described later.

The tantalum oxide particles preferably contain polyhedral-shaped particles. The tantalum oxide particles according to the embodiment contain molybdenum, and the particle shape can be stably controlled to a polyhedral shape by controlling the amount and presence state of molybdenum mixed in a production method described later.

In the present specification, the term “polyhedral shape” represents a hexahedron or higher polyhedron, preferably an octahedron or higher polyhedron, and more preferably a decahedron to triacontahedron. Polyhedral shapes include a cubic shape and a prismatic shape.

The tantalum oxide particles according to the embodiment preferably have a MoO₃ content (M₁) of 0.1% to 10.0% by mass relative to 100% by mass of the tantalum oxide particles, determined by XRF analysis of the tantalum oxide particles.

The MoO₃ content (M₁) is more preferably 0.3% to 8.0% by mass and still more preferably 0.5% to 6.0% by mass. The MoO₃ content (M₁) is a value determined by forming a MoO₃ calibration curve in advance and performing XRF (X-ray fluorescence) analysis of the tantalum oxide particles to determine the MoO₃ content as the MoO₃ content relative to 100% by mass of the tantalum oxide particles.

The tantalum oxide particles according to the embodiment preferably have a Ta₂O₅ content (T₁) of 85.0% to 99.9% by mass relative to 100% by mass of the tantalum oxide particles, determined by XRF analysis of the tantalum oxide particles.

The Ta₂O₅ content (T₁) is more preferably 87.0% to 99.7% by mass and still more preferably 89.0% to 99.5% by mass.

The Ta₂O₅ content (T₁) is a value determined by forming a Ta₂O₅ calibration curve in advance and performing XRF (X-ray fluorescence) analysis of the tantalum oxide particles to determine the Ta₂O₅ content as the Ta₂O₅ content relative to 100% by mass of the tantalum oxide particles.

The tantalum oxide particles according to the embodiment preferably have a crystallite size at 2θ=22.8° of 160 nm or more. The polyhedral-shaped tantalum oxide particles according to the embodiment have a crystallite size at 2θ=22.8° of as large as 160 nm or more, and thus crystallinity can be maintained high, the average particle diameter can be easily controlled, and the particle size distribution can be easily controlled to be narrow.

In the present specification, a value of crystallite size calculated by using a Scherrer equation from the half width of a peak appearing at 2θ=22.8°±0.2° in measurement by an X-ray diffraction method (XRD method) is used as the crystallite size at 2θ=22.8° of the tantalum oxide particles.

The crystallite size at 2θ=22.8° of the tantalum oxide particles according to the embodiment is more preferably 180 nm or more, still more preferably 200 nm or more, and particularly preferably 210 nm or more. The crystallite size at 2θ=22.8° of the tantalum oxide particles according to the embodiment may be 800 nm or less, 600 nm or less, 500 nm or less, or 400 nm or less. The crystallite size at 2θ=22.8° of the tantalum oxide particles according to the embodiment may be 160 nm or more and 800 nm or less and is preferably 180 nm or more and 600 nm or less, more preferably 200 nm or more and 500 nm or less, and still more preferably 210 nm or more and 400 nm or less.

The crystallite size at 2θ=36.6° of the tantalum oxide particles according to the embodiment is preferably 100 nm or more, more preferably 120 nm or more, and still more preferably 140 nm or more. The crystallite size at 2θ=36.6° of the tantalum oxide particles according to the embodiment may be 600 nm or less, 550 nm or less, or 500 nm or less. The crystallite size at 2θ=36.6° of the tantalum oxide particles according to the embodiment is preferably 100 nm or more and 600 nm or less, more preferably 120 nm or more and 550 nm or less, and still more preferably 140 nm or more and 500 nm or less.

In the present specification, a value of crystallite size calculated by using a Scherrer equation from the half width of a peak appearing at 2θ=36.6°±0.2° in measurement by an X-ray diffraction method (XRD method) is used as the crystallite size at 2θ=36.6° of the tantalum oxide particles.

The polyhedral-shaped tantalum oxide particles according to the embodiment have a crystallite size at 2θ=22.8° of as large as 160 nm or more and a crystallite size at 2θ=36.6° of as large as 100 nm or more, thereby enabling crystallinity to be maintained high, the average particle diameter to be easily controlled, and the particle size distribution to be easily controlled to be narrow.

The tantalum oxide particles according to the embodiment preferably have a Ta₂O₅ content (T₂) of 70.0% to 99.5% by mass relative to 100% by mass of the surface layers of the tantalum oxide particles, determined by XPS surface analysis of the tantalum oxide particles, and have a MoO₃ content (M₂) of 0.5% to 30.0% by mass relative to 100% by mass of the surface layers of the tantalum oxide particles, determined by XPS surface analysis of the tantalum oxide particles.

The Ta₂O₅ content (T₂) represents a value determined, as the Ta₂O₅ content relative to 100% by mass of the surface layers of the tantalum oxide particles, by obtaining the presence ratio (atom %) of each element by XPS surface analysis of the tantalum oxide particles using X-ray photoelectron spectroscopy (XPS: X-Ray Photoelectron Spectroscopy) and calculating the tantalum content in terms of oxide.

The MoO₃ content (M₂) represents a value determined, as the MoO₃ content relative to 100% by mass of the surface layers of the tantalum oxide particles, by obtaining the presence ratio (atom %) of each element by XPS surface analysis of the tantalum oxide particles using X-ray photoelectron spectroscopy (XPS: X-Ray Photoelectron Spectroscopy) and calculating the molybdenum content in terms of oxide.

Herein, the term “surface layer” represents within 10 nm or less from the surface of each of the tantalum oxide particle according to the embodiment. The distance corresponds to the detection depth of XPS used for measurement in examples.

Herein, the expression “surface enrichment” represents a state where the mass of the molybdenum or molybdenum compound per unit volume in the surface layers is larger than the mass of the molybdenum or molybdenum compound per unit volume in portions other than the surface layers.

The tantalum oxide particles according to the embodiment contain molybdenum selectively being rich in the surface layers of the tantalum oxide particles. When the MoO₃ content (M₂) relative to 100% by mass of the surface layers of the tantalum oxide particles, determined by XPS surface analysis of the tantalum oxide particles, is higher than the MoO₃ content (M₁) relative to 100% by mass of the tantalum oxide particles, determined by XRF analysis of the tantalum oxide particles, molybdenum can be confirmed to be selectively rich in the surface layers of the tantalum oxide particles.

The ratio of surface enrichment (M₂/M₁) of the MoO₃ content (M₂) relative to 100% by mass of the surface layers of the tantalum oxide particles, determined by XPS surface analysis of the tantalum oxide particles, to the MoO₃ content (M₁) relative to 100% by mass of the tantalum oxide particles, determined by XRF analysis of the tantalum oxide particles, is preferably more than 1, more preferably 1.01 to 8.0, still more preferably 1.03 to 6.0, and particularly preferably 1.05 to 4.0.

The specific surface area determined by a BET method for the tantalum oxide particles according to the embodiment may be 10 m²/g or less, 5 m²/g or less, 1 m²/g or less, or m²/g or less.

The specific surface area determined by a BET method for the tantalum oxide particles according to the embodiment may be within a range of 0.01 to 10 m²/g, 0.03 to 5 m²/g, to 1 m²/g, or 0.1 to 0.6 m²/g.

The average particle diameter of primary particles of the tantalum oxide particles according to the embodiment may be 2 to 1000 μm, 3 to 500 μm, 4 to 400 μm, or 5 to 200 μm.

The average particle diameter of primary particles of the tantalum oxide particles represents an average value of primary particle diameters of at least 50 primary particles when the tantalum oxide particles are photographed by a scanning electron microscope (SEM), the long diameters (Ferret diameters of the longest portions observed) and the short diameters (the short ferret diameters in the direction perpendicular to the ferret diameters of the longest portions) are measured for minimum-unit particles (that is, primary particles) constituting an aggregate in a two-dimensional image, and an average value thereof is regarded as the primary particle diameter.

The tantalum oxide particles according to the embodiment can be provided as an aggregate of tantalum oxide particles, and values determined by using the aggregate as a sample can be used as the values of the MoO₃ content, the Ta₂O₅ content, and the specific surface area.

The tantalum oxide particles according to the embodiment can be produced by, for example, a “method for producing tantalum oxide particles” described later.

The tantalum oxide particles of the present invention are not limited to tantalum oxide particles produced by the method for producing tantalum oxide particles according to an embodiment described below.

The tantalum oxide particles according to the embodiment can be provided with the characteristics of both tantalum oxide and molybdenum, and are very useful.

### [Method for Producing Tantalum Oxide Particles]

The production method according to the embodiment is a method for producing the tantalum oxide particles described above and includes firing a tantalum compound in the presence of a molybdenum compound.

The method for producing tantalum oxide particles according to the embodiment can produce the tantalum oxide particles containing molybdenum according to the embodiment of the present invention described above.

The method for producing tantalum oxide particles according to the embodiment includes firing the tantalum compound in the presence of the molybdenum compound and thus the method can stably control the particle shape, can increase the crystallite size of the tantalum oxide particles, can allow the tantalum oxide particles to have a polyhedral shape, can decrease aggregability of the tantalum oxide particles, and can improve dispersibility of the tantalum oxide particles.

The preferred method for producing tantalum oxide particles includes a step (mixing step) of mixing the tantalum compound with the molybdenum compound to form a mixture and a step (firing step) of firing the mixture.

### [Mixing Step]

The mixing step is a step of mixing the tantalum compound with the molybdenum compound to form a mixture. The contents of the mixture are described below.

### [Tantalum Compound]

The tantalum compound is not limited as long as it is a compound which can be converted to tantalum oxide by firing. The tantalum compound may be tantalum oxide (a-Ta₂O₅, β-Ta₂O₅, γ-Ta₂O₅, δ-Ta₂O₅, TaO₂, TaO, or the like), tantalum hydroxide (Ta(OH)₅), or tantalum halide (TaCl₅, TaBr₅, or the like), and is not limited to these. Tantalum oxide is preferred.

### [Molybdenum Compound]

Examples of the molybdenum compound include molybdenum oxide, molybdenum sulfide, molybdic acid, and the like.

Examples of molybdenum oxide include molybdenum dioxide, molybdenum trioxide, and the like, and molybdenum trioxide is preferred.

The method for producing tantalum oxide particles according to the embodiment uses the molybdenum compound as a flux agent. In the present specification, the production method using the molybdenum compound as the flux agent may be simply referred to as the “flux method”. In addition, the molybdenum compound is reacted with the tantalum compound at a high temperature by firing to form tantalum molybdate, and then when the tantalum molybdate is further decomposed into tantalum oxide and molybdenum oxide at a higher temperature, the molybdenum compound is considered to be taken into tantalum oxide particles. The molybdenum oxide is removed by sublimation into the outside of the system, and at the same time in this process, the molybdenum compound is considered to be reacted with the tantalum compound to form the molybdenum compound in the surface layers of tantalum oxide particles. With respect to the mechanism of forming the molybdenum compound contained in the tantalum oxide particles, in more detail, it is considered that Mo—O—Ta is formed by reaction of molybdenum with Ta atoms in the surface layers of tantalum oxide particles, and high-temperature firing causes Mo desorption and, at the same time, forms molybdenum oxide, a compound having Mo—O—Ta bond, or the like in the surface layers of the tantalum oxide particles.

The molybdenum oxide not taken into the tantalum oxide particles can be recovered by sublimation and can also be reused. This can decrease the amount of molybdenum oxide adhering to the surfaces of the tantalum oxide particles and can maximally impart the original properties of tantalum oxide particles.

In the present invention, a material having a sublimable property in the production method described later is referred to as the “flux agent”.

In the method for producing tantalum oxide particles according to the embodiment, the molar ratio of molybdenum atom in the molybdenum compound to tantalum atom in the tantalum compound is preferably Mo/Ta=0.2 or more, more preferably 0.4 or more, still more preferably 0.6 or more, and particularly preferably 0.8 or more.

The upper limit of the molar ratio of molybdenum atom in the molybdenum compound to tantalum atom in the tantalum compound may be properly determined and, from the viewpoint of reducing the molybdenum compound used and improving production efficiency, the molar ratio may be, for example, Mo/Ta=14 or less, 12 or less, 10 or less, or 9 or less.

An example of the numerical range of the molar ratio of molybdenum atom in the molybdenum compound to tantalum atom in the tantalum compound is, for example, preferably Mo/Ta=0.2 to 14, more preferably 0.4 to 12, still more preferably 0.6 to 10, and particularly preferably 0.8 to 9.

There is a tendency that the average particle diameter of primary particles of the resultant tantalum oxide particles increases with increasing amount of molybdenum used relative to tantalum.

In the method for producing tantalum oxide particles according to the embodiment, the mixing amounts of the tantalum compound and the molybdenum compound are not particularly limited, but preferably, the mixture can be prepared by mixing 35% by mass or more of the tantalum compound with 65% by mass or less of the molybdenum compound relative to 100% by mass of the mixture, and then the mixture can be fired. More preferably, the mixture can be prepared by mixing 40% by mass or more and 99% by mass or less of the tantalum compound is mixed with 1% by mass or more and 60% by mass or less of the molybdenum compound relative to 100% by mass of the mixture, and then the mixture can be fired. Still more preferably, the mixture can be prepared by mixing 45% by mass or more and 98% by mass or less of the tantalum compound is mixed with 2% by mass or more and 55% by mass or less of the molybdenum compound relative to 100% by mass of the mixture, and then the mixture can be fired.

By using each of the compounds within the range described above, the amount of molybdenum compound contained in the resultant tantalum oxide particles can be made more suitable, a polyhedral shape can be satisfactorily formed, and the tantalum oxide particles having a crystallite size at 2θ=22.8° of 160 nm or more can be produced.

### [Firing Step]

The firing step is a step of firing the mixture. The tantalum oxide particles according to the embodiment of the present invention can be produced by firing the mixture. As described above, the production method is referred to as the “flux method”.

The flux method is classified as a solution method. In further detail, the flux method is a crystal growth method utilizing a crystal-flux binary system phase diagram which indicates a eutectic type. The mechanism of the flux method is supposed as follows: When a mixture of a solute and a flux is heated, the solute and the flux become a liquid phase. In this case, the flux is a fusing agent, in other words, the solute-flux binary system phase diagram indicates a eutectic type, and thus the solute is melted at a temperature lower than its melting point, forming a liquid phase. In this state, evaporation of the flux decreases the flux concentration, in other words, decreases the effect of lowering the melting point of the solute by the flux, and crystal growth of the solute takes place by flux evaporation serving as driving force (flux evaporation method). The crystal growth of the solute can also be caused by cooling the liquid phase of the solute and the flux (slow cooling method).

The flux method has the merits that crystal growth can be caused at a temperature significantly lower than the melting point, that the crystal structure can be precisely controlled, and that a polyhedral crystal having a euhedral shape can be formed.

In producing the tantalum oxide particles by the flux method using the molybdenum compound as the flux, the mechanism thereof is not necessarily clear, but the mechanism is, for example, supposed as follows: When the tantalum compound is fired in the presence of the molybdenum compound, tantalum molybdate is first formed. In this case, as understood from the above description, the tantalum molybdate causes crystal growth of tantalum oxide at a temperature lower than the melting point of tantalum oxide. Then, the tantalum molybdate is decomposed by, for example, evaporating the flux, and the tantalum oxide particles can be produced by crystal growth. That is, the molybdenum compound functions as the flux, and the tantalum oxide particles are produced through the tantalum molybdate serving as an intermediate.

The flux method can produce the polyhedral-shaped tantalum oxide particles containing molybdenum.

The firing method is not particularly limited and can be performed by a well-known common method. When the firing temperature exceeds 650° C., the tantalum compound is reacted with the molybdenum compound to form tantalum molybdate. Further, when the firing temperature becomes 800° C. or more, the tantalum molybdate is decomposed to form the tantalum oxide particles. Also, in the tantalum oxide particles, when the tantalum molybdate is decomposed into tantalum oxide and molybdenum oxide, the molybdenum compound is considered to be taken into the tantalum oxide particles.

In addition, the states of the tantalum compound and the molybdenum compound during firing are not particularly limited as long as the molybdenum compound and the tantalum compound are present within the same space allowing for reaction therebetween. Specifically, powders of the molybdenum compound and the tantalum compound may be simply mixed together, may be mechanically mixed by using a grinder or the like, or may be mixed by using a mortar or the like, and mixing may be performed either in a dry state or a wet state.

The firing temperature condition is not particularly limited and is properly determined according to the average particle diameter of the intended tantalum oxide particles and the formation, dispersibility, etc. of the molybdenum compound in the tantalum oxide particles. With respect to the firing temperature, the maximum firing temperature is close to the decomposition temperature of tantalum molybdate and is preferably 800° C. or more and more preferably 900° C. or more.

In general, high-temperature firing at 1500° C. or more, close to the melting point of tantalum oxide, is required for controlling the shape of tantalum oxide obtained after firing, but there is a big problem for industrial use from the viewpoint of load on a firing furnace and fuel cost.

The production method of the present invention can be performed even at a high temperature such as over 1500° C., but even at a temperature of 1300° C. or less, much lower than the melting point of tantalum oxide, the polyhedral-shaped tantalum oxide particles having a large crystallite size at 2θ=22.8° and a large crystallite size at 2θ=36.6° can be formed regardless of the shape of the precursor.

According to an embodiment of the present invention, the polyhedral-shaped tantalum oxide particles having a large crystallite size at 2θ=22.8° and a large crystallite size at 2θ=36.6° can be efficiently formed at low cost even under the condition of the maximum firing temperature of 800° C. to 1600° C. Firing at the maximum firing temperature of 850° C. to 1500° C. is more preferred and firing at the maximum firing temperature within a range of 900° C. to 1400° C. is most preferred.

From the viewpoint of production efficiency and from the viewpoint of avoiding damage to a charge vessel (crucible or sagger) due to rapid thermal expansion, the heating rate is preferably 1 to 30° C./min, more preferably 2 to 20° C./min, and still more preferably 3 to 10° C./min.

With respect to the firing time, preferably, the time of temperature rising to the predetermined maximum firing temperature is within a range of 15 minutes to 10 hours, and, the retention time after the predetermined maximum firing temperature is reached is within a range of 1 to 30 hours. In order to efficiently form the tantalum oxide particles, the retention time at the maximum firing temperature is more preferably about 2 to 15 hours.

By selecting the conditions including the maximum firing temperature of 800° C. to 1600° C. and the maximum firing temperature retention time of 2 to 15 hours, the polyhedral-shaped tantalum oxide particles containing molybdenum can be easily produced while being hardly aggregated.

The firing atmosphere is not particularly limited as long as the effect of the present invention can be achieved, and, for example, it is preferably an oxygen-containing atmosphere such as air or oxygen or an inert atmosphere such as nitrogen, argon, or carbon dioxide, and considering the cost aspect, an air atmosphere is more preferred.

An apparatus for firing is not necessarily limited, and a so-called firing furnace can be used. The firing furnace is preferably composed of a material which is not reacted with the sublimated molybdenum oxide, and further a firing furnace with high sealability is preferably used for efficiently using molybdenum oxide.

Thus, the amount of molybdenum compound adhering to the surfaces of the tantalum oxide particles can be decreased, and the original properties of the tantalum oxide particles can be maximally imparted.

### [Molybdenum Removing Step]

The method for producing tantalum oxide particles according to the embodiment may further include, after the firing step, the molybdenum removing step of removing at least a portion of molybdenum according to demand.

As described above, molybdenum is associated with sublimation during firing, and thus by controlling the firing time, the firing temperature, etc., it is possible to control the amount of molybdenum oxide present in the surface layers of the tantalum oxide particles and to control the content and presence state of molybdenum oxide present in portions (inner layers) other than the surface layers of the tantalum oxide particles.

Molybdenum can be adhered to the surfaces of the tantalum oxide particles. As a method other than sublimation, the molybdenum can be removed by a method of washing with water, an aqueous ammonia solution, an aqueous sodium hydroxide solution, or an aqueous acid solution. In addition, molybdenum may not be removed from the tantalum oxide particles, but molybdenum is preferably removed from at least the surfaces because in a case such as when it is used by dispersion in a dispersion medium based on any of various binders, the original properties of tantalum oxide can be sufficiently exhibited, and the molybdenum present in the surfaces causes no inconvenience.

In this case, the content of molybdenum oxide can be controlled by properly changing the concentration and amount of water, aqueous ammonia solution, aqueous sodium hydroxide solution, or aqueous acid solution used, the washing portion, the washing time, etc.

### [Grinding Step]

The fired product produced through the firing step may not satisfy a preferred particle diameter range of the present invention due to aggregation of the tantalum oxide particles. Therefore, if required, the tantalum oxide particles may be ground so as to satisfy the preferred particle diameter range of the present invention.

The method for grinding the fired product is not particularly limited, and a usual known grinding method, such as a ball mill, a jaw crusher, a jet mill, a disk mill, a spectro mill, a grinder, a mixer mill, or the like, can be applied.

### [Classification Step]

The tantalum oxide particles are preferably classified in order to improve the fluidity of a powder by adjusting the average particle diameter or to suppress an increase in viscosity when mixed with a binder for forming a matrix. The “classification” represents an operation of dividing the particles into groups according to particle sizes.

The classification may be either a wet type or a dry type, but dry-type classification is preferred from the viewpoint of productivity. Examples of dry-type classification include classification with a sieve, air classification by a difference between centrifugal force and fluid drag, and the like. From the viewpoint of classification precision, air classification is preferred and can be performed by using a classifier such as an airflow classifier, a swirl airflow classifier, a forced vortex centrifugal classifier, a semi-free vortex centrifugal classifier, or the like.

The grinding step and the classification step can be performed at a necessary stage. For example, the average particle diameter of the resultant tantalum oxide particles can be adjusted by the presence of grinding and classification and by selecting the conditions thereof.

The tantalum oxide particle of the present invention or tantalum oxide particles produced by the production method of the present invention are preferably little or not aggregated from the viewpoint that the original properties can be easily exhibited, their own handleability is excellent, and dispersibility is more excellent in the case of use by dispersion in a dispersion medium. The method for producing tantalum oxide particles preferably produces tantalum oxide particles with little or no aggregation without the grinding step and the classification step because the steps described above need not be performed, and the tantalum oxide particles having the intended excellent properties can be produced with high productivity.

### EXAMPLES

The present invention is described in further detail below by showing examples, but the present invention is not limited to these examples.

### Comparative Example 1

Tantalum oxide (manufactured by Aladdin Co., Ltd. (China), Ta₂O₅) was used for tantalum oxide particles of Comparative Example 1. FIG. 4 shows a SEM photograph of tantalum oxide particles of Comparative Example 1. The shape of the particles was amorphous.

### Comparative Example 2

### [Production of Tantalum Oxide Particles]

In a vessel, 10.0 g of tantalum oxide (manufactured by Aladdin Co., Ltd. (China), Ta₂O₅) was taken, placed in a sagger made of aluminum oxide, and then heat-treated under the following conditions.

### [Heat Treatment]

A heating furnace SC-2045D-SP manufactured by Motoyama Co., Ltd. was used, and the temperature was increased from room temperature to 1100° C. at about 5° C./min, maintained at 1100° C. for 24 hours, and then lowered.

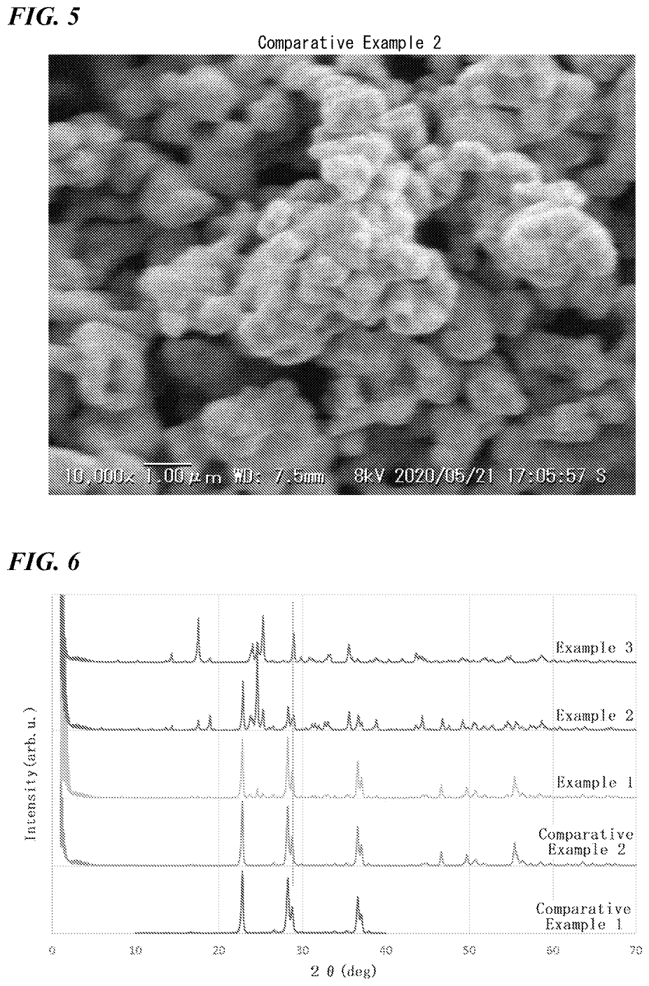

FIG. 5 shows a SEM photograph of the resultant tantalum oxide particles of Comparative Example 2. It could be confirmed that the tantalum oxide particles of Comparative Example 2 have a particle diameter increased by particle growth as compared with the tantalum oxide particles of Comparative Example 1. Also, poor dispersibility and the occurrence of aggregation were observed. The shapeless particle shape remained.

### Example 1

### [Production of Tantalum Oxide Particles]

In a mortar, 10.0 g of tantalum oxide (manufactured by Aladdin Co., Ltd. (China), Ta₂O₅) and 0.5 g of molybdenum trioxide (Chengdu Hongbo Industrial Co., Ltd. (China), MoO₃) were mixed to prepare a mixture. The resultant mixture was placed in a crucible and fired at 1100° C. for 24 hours in a ceramic electric furnace. After the temperature was lowered, the crucible was taken out from the ceramic electric furnace, producing 10.2 g of light pink powder.

Then, 9.5 g of the resultant powder was dispersed in 100 mL of 0.5% ammonia water, and the dispersion solution was stirred at room temperature (25° C. to 30° C.) for 3 hours and then filtered to remove ammonia water. The residue was washed with water and dried to remove the molybdenum remaining on the particle surfaces, thereby producing 9.4 g of light pink powder of tantalum oxide particles.

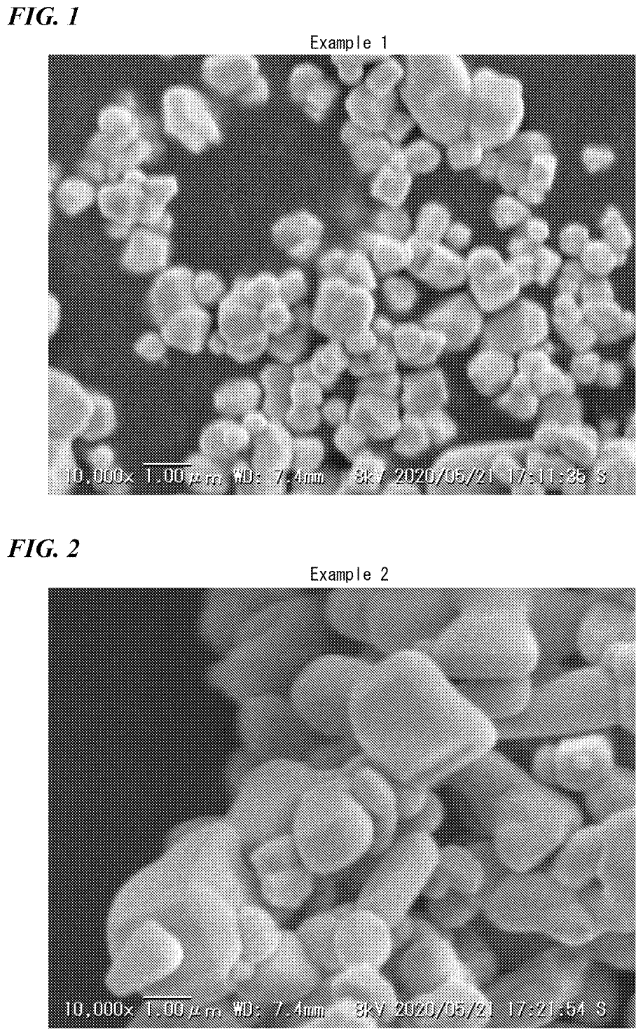

FIG. 1 shows a SEM photograph of the resultant tantalum oxide particles of Example 1. The tantalum oxide particles having a polyhedral shape close to a cubic shape were observed. Remarkable aggregation was not observed with the tantalum oxide particles of Example 1, and the tantalum oxide particles had good dispersibility as compared with those of Comparative Examples 1 and 2.

### Example 2

### [Production of Tantalum Oxide Particles]

Light pink powder of tantalum oxide particles was produced by the same method as in Example 1 except that in Example 1, the reagent amounts of raw materials were change to 10.0 g of tantalum oxide (manufactured by Aladdin Co., Ltd. (China), Ta₂O₅) and 2.0 g of molybdenum trioxide (Chengdu Hongbo Industrial Co., Ltd. (China), MoO₃).

FIG. 2 shows a SEM photograph of the resultant tantalum oxide particles of Example 2. The tantalum oxide particles having a polyhedral shape were observed. Remarkable aggregation was not observed with the tantalum oxide particles of Example 2, and the tantalum oxide particles had good dispersibility as compared with those of Comparative Examples 1 and 2.

### Example 3

### [Production of Tantalum Oxide Particles]

Light pink powder of tantalum oxide particles was produced by the same method as in Example 1 except that in Example 1, the reagent amounts of raw materials were change to 10.0 g of tantalum oxide (manufactured by Aladdin Co., Ltd. (China), Ta₂O₅) and 10.0 g of molybdenum trioxide (Chengdu Hongbo Industrial Co., Ltd. (China), MoO₃).

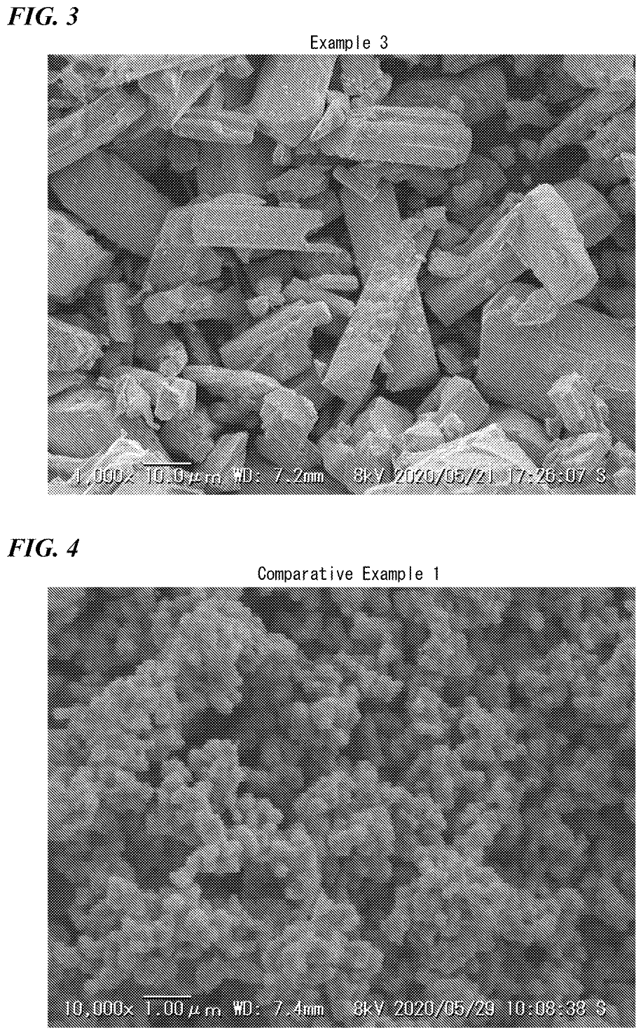

FIG. 3 shows a SEM photograph of the resultant tantalum oxide particles of Example 3. The tantalum oxide particles having a polyhedral shape close to a prismatic shape were observed. Remarkable aggregation was not observed with the tantalum oxide particles of Example 3, and the tantalum oxide particles had good dispersibility as compared with those of Comparative Examples 1 and 2.

### [Measurement of Average Particle Diameter of Primary Particles of Tantalum Oxide Particles]

The tantalum oxide particles were photographed by a scanning electron microscope (SEM). The long diameters (Ferret diameters of the longest portions observed) and the short diameters (the short ferret diameters in the direction perpendicular to the ferret diameters of the longest portions) were measured for minimum-unit particles (that is, primary particles) constituting aggregates in a two-dimensional image, and an average value thereof was regarded as the primary particle diameter. The same operation was performed for 50 primary particles having long diameters and short diameters which could be measured, and an average particle diameter of primary particle was calculated from the average value of the primary particle diameters of primary particles. The results are shown in Table 1.

### [Measurement of Crystallite Size]

An X-ray diffractometer (SmartLab manufactured by Rigaku Corporation) provided with a high-intensity high-resolution crystal analyzer (CALSA) as a detector was used, and powder X-ray diffraction (2θ/θ method) measurement was performed under the following measurement conditions. Analysis was made by using the CALSA function of an analysis software (PDXL) manufactured by Rigaku Corporation, and the crystallite size at 2θ=22.8° was calculated from the half width of a peak appearing at 2θ=22.8° using a Scherrer equation, and the crystallite size at 2θ=36.6° was calculated from the half width of a peak appearing at 2θ=36.6° using a Scherrer equation. However, in Example 3, peaks with a determinable half width were not detected at 2θ=22.8° and 2θ=36.6°. The results are shown in Table 1.

### [Measurement Conditions for Powder X-Ray Diffraction Method]

Tube voltage: 45 kV
Tube current: 200 mA
Scan speed: 0.05°/min
Scan range: 10° to 70°
Step: 0.002°
βs: 20 rpm
Apparatus standard width: 0.026° calculated by using a standard silicon powder (NIST, 640d) formed by U.S. National Institute of Standards and Technology was used.

### [Crystal Structure Analysis: XRD (X-Ray Diffraction) Method]

A holder for a measurement sample, which had a depth of 0.5 mm, was filled with a sample of the tantalum oxide particles of each of Examples 1 to 3 and Comparative Examples 1 and 2 and set in a wide-angle X-ray diffractometer (XRD) (manufactured by Rigaku Corporation Ultima IV), and XRD (X-ray diffraction) measurement was performed under the conditions including Cu/Kα line, 40 kV/40 mA, a scan speed of 2°/min, and a scan range of 10° to 70°. By using MoO₃ and Ta₂O₅ calibration curves previously formed, the MoO₃ and Ta₂O₅ contents was determined as the MoO₃ content and Ta₂O₅ content relative to 100% by mass of the tantalum oxide particles. FIG. 6 shows the results of XRD measurement of the tantalum oxide particles of Examples 1 to 3 and Comparative Examples 1 and 2.

With the tantalum oxide particles of Examples 1 and 2 and Comparative Examples 1 and 2, crystal peaks derived from tantalum oxide were observed at 2θ=22.8° and 2θ=36.6°. With the tantalum oxide particles of Example 3, crystal peaks derived from tantalum oxide were observed near 2θ=17.5° and 2θ=25.3°.

### [Measurement of Specific Surface Area of Tantalum Oxide Particles]

The specific surface area of the tantalum oxide particles was measured by a specific surface area meter (BELSORP-mini manufactured by MicrotracBEL Corp.) and the surface area per gram of sample measured from the adsorption amount of nitrogen gas by a BET method was calculated as the specific surface area (m²/g). The results are shown in Table 1.

### [Measurement of Purity of Tantalum Oxide Particles: XRF (X-Ray Fluorescence) Analysis]

About 70 mg of a tantalum oxide particle sample was taken on a filter paper, covered with a PP film, and analyzed by XRF (X-ray fluorescence) using X-ray fluorescence analyzer Primus IV (manufactured by Rigaku Corporation) under the following conditions.

### Measurement Conditions

### EZ Scan Mode

Measurement element: F to U
Measurement time: standard
Measurement diameter: 10 mm
Balance (balance component): No

Table 1 shows the results of the Ta₂O₅ content (T₁) relative to 100% by mass of the tantalum oxide particles and the MoO₃ content (M₁) relative to 100% by mass of the tantalum oxide particles, which were obtained by XRF analysis.

### [XPS Surface Analysis]

In surface elemental analysis of the tantalum oxide particles, each of the element contents atom % in surface layers were determined by X-ray photoelectron spectroscopy (XPS: X ray Photoelectron Spectroscopy) using QUANTERA SXM manufactured by ULVAC-PHI, Inc. and monochromatic Al-Kα line as an X-ray source under the following conditions.
X-ray source: monochromatic Al-Kα, beam diameter 100 μmφ, output 25 W
Measurement: area measurement (1000-μm square), n=3
Charge correction: C1s=284.8 eV

In order to facilitate comparison with the XRF results, the Ta₂O₅ content (T₂) (% by mass) relative to 100% by mass of the surface layers of the tantalum oxide particles and the MoO₃ content (M₂) (% by mass) relative to 100% by mass of the surface layers of the tantalum oxide particles were determined by measuring the tantalum content and the molybdenum content in terms of oxide in the surface layers of tantalum oxide particles. The results are shown in Table 1.

Thus, was determined the ratio of surface enrichment (M₂/M₁) of the MoO₃ content (M₂) determined by XPS surface analysis of the tantalum oxide particles to the MoO₃ content (M₁) determined by XRF analysis of the tantalum oxide particles. The results are shown in Table 1.

The tantalum oxide particles of Examples 1 to 3 are polyhedral-shaped tantalum oxide particles containing molybdenum and having a controlled shape different from the shape of usual tantalum oxide particles, and having lower aggregability and relatively larger crystallite size than those of usual tantalum oxide particles.

With the tantalum oxide particles of Examples 1 to 3, the MoO₃ content (M₂) relative to 100% by mass of the surface layers of tantalum oxide particles determined by XPS surface analysis of the tantalum oxide particles is higher than the MoO₃ content (M₁) relative to 100% by mass of the tantalum oxide particles determined by XRF analysis of the tantalum oxide particles. Thus, it can be confirmed that molybdenum is selectively rich in the surface layers of the tantalum oxide particles.

The tantalum oxide particles of Examples 1 to 3 contain molybdenum in the surfaces thereof and thus can be expected to exhibit various functions by molybdenum.

Each of the configurations and combinations thereof according to each of the embodiments is only an example, and addition, elimination, replacement, and other changes of the configurations can be made within a range not deviating from the gist of the present invention. In addition, the present invention is not limited by the embodiments but is limited only by the scope of claims.

### INDUSTRIAL APPLICABILITY

The tantalum oxide particles of the present invention can be expected to be used as an electronic ceramic material such as a capacitor, a dielectric material, a piezoelectric material, or the like, an optical material, a catalyst material, an electronics material, and a functional filler.

TABLE 1

| | | | Comparative | Comparative | | | |
|---|---|---|---|---|---|---|---|
| | | | Example 1 | Example 2 | Example 1 | Example 2 | Example 3 |
| Ta₂O₅ | | g | — | 10.0 | 10.0 | 10.0 | 10.0 |
| | | % by | 100.0 | 100.0 | 95.2 | 83.3 | 50.0 |
| | | mass | | | | | |
| MoO₃ | | g | — | 0.0 | 0.5 | 2.0 | 10.0 |
| | | % by | 0.0 | 0.0 | 4.8 | 16.7 | 50.0 |
| | | mass | | | | | |
| Mo/Ta | | Molar | 0.00 | 0.00 | 0.81 | 2.84 | 8.49 |
| | | ratio | | | | | |
| Maximum firing | | ° C. | — | 1100 | | | |
| temperature | | | | | | | |
| Firing time | | h | — | 24 | | | |
| Shape | (SEM) | | Amorphous | Amorphous | Cube | Polyhedron | Prismatic |
| | | | | | | | shape |
| Average | (SEM) | μm | 0.40 | 0.60 | 0.75 | 3.5 | 30 |
| particle | | | | | | | |
| diameter | | | | | | | |
| Crystallite | 22.8° | nm | 131.0 | 153.0 | 216.0 | 292.0 | — |
| size | 36.6° | nm | 50 | 88 | 143 | 162 | — |
| XRF | Ta₂O₅ | % by | 100.0 | 100.0 | 99.3 | 95.9 | 89.4 |
| analysis | (T₁) | mass | | | | | |
| | MoO₃ | % by | 0.0 | 0.0 | 0.7 | 3.7 | 5.9 |
| | (M₁) | mass | | | | | |
| XPS | Ta₂O₅ | % by | — | — | 99.2 | 94.8 | 77.2 |
| surface | (T₂) | mass | | | | | |
| analysis | MoO₃ | % by | — | — | 0.8 | 5.2 | 22.8 |
| | (M₂) | mass | | | | | |
| Surface | MoO₃ | — | — | — | 1.1 | 1.4 | 3.9 |
| uneven | (M₂/M₁) | | | | | | |
| distribution | | | | | | | |
| ratio | | | | | | | |
| Specific | (BET | m²/g | 5 | 0.7 | 0.55 | 0.31 | 0.12 |
| surface | method) | | | | | | |
| area | | | | | | | |

1. Tantalum oxide particles comprising molybdenum.

2. The tantalum oxide particles according to claim 1, wherein the tantalum oxide particles contain polyhedral-shaped particles.

3. The tantalum oxide particles according to claim 1, wherein the MoO3 content (Mi) relative to 100% by mass of the tantalum oxide particles, determined by XRF analysis of the tantalum oxide particles, is 0.1% to 10.0% by mass.

4. The tantalum oxide particles according to claim 1, wherein the Ta2Os content (T1) relative to 100% by mass of the tantalum oxide particles, determined by XRF analysis of the tantalum oxide particles, is 85.0% to 99.9% by mass.

5. The tantalum oxide particles according to claim 1, wherein the crystallite size of the tantalum oxide particles at 28=22.8° is 160 nm or more.

6. The tantalum oxide particles according to claim 1, wherein the crystallite size of the tantalum oxide particles at 28=36.6° is 100 nm or more.

7. The tantalum oxide particles according to claim 1, wherein the Ta2Os content (T2) relative to 100% by mass of the surface layers of the tantalum oxide particles, determined by XPS surface analysis of the tantalum oxide particles, is to 99.5% by mass, and the MoO3 content (M2) relative to 100% by mass of the surface layers of the tantalum oxide particles, determined by XPS surface analysis of the tantalum oxide particles, is 0.5% to 30.0% by mass.

8. The tantalum oxide particles according to claim 1, wherein the molybdenum is selectively rich in the surface layers of the tantalum oxide particles.

9. The tantalum oxide particles according to claim 1, wherein the specific surface area determined by a BET method is 10 m2/g or less.

10. A method for producing tantalum oxide particles, including firing a tantalum compound in the presence of a molybdenum compound.

11. The method for producing tantalum oxide particles according to claim 10, wherein the molybdenum compound is molybdenum oxide.

12. The method for producing tantalum oxide particles according to claim 10, wherein the maximum firing temperature of firing the tantalum compound is 800° C. to 1600° C.

13. The method for producing tantalum oxide particles according to claim 10, wherein the molar ratio of molybdenum atom in the molybdenum compound to tantalum atom in the tantalum compound is Mo/Ta=0.2 or more.
